(19) United States
(12) Patent Application Publication
(10) Pub. No.: US 2008/0187702 A1
(43) Pub. Date: Aug. 7, 2008

(54) Method of reducing the increase in release force in the production of no-label-look labels

(75) Inventors: Michael Ferenz, Essen (DE); Hardi Dohler, Dusseldorf (DE); Winfried Hamann, Essen (DE); Christian Mund, Essen (DE); Juergen Pomorin, Essen (DE); Philipp Tomuschat, Essen (DE)

Correspondence Address: FROMMER LAWRENCE & HAUG, 745 FIFTH AVENUE- 10TH FL., NEW YORK, NY, 10151, US

(73) Assignee: Evonik Goldschmidt GmbH, Essen (DE)

(21) Appl. No.: 12/024,305

(22) Filed: Feb. 1, 2008

(30) Foreign Application Priority Data
Feb. 3, 2007 (DE) 10 2007 005 508.2

(51) Int. Cl. B32B 33/00; B05D 5/10; B01F 17/00; C08F 20/10; C09D 11/10

(52) U.S. Cl. 428/41.5; 427/207.1; 526/318; 524/287; 524/323

(57) ABSTRACT

The invention relates to acrylate dispersion adhesives containing at least one UV absorber selected from the group consisting of benzoate esters and benzoic ester derivatives, cinnamic esters and cinnamic ester derivatives, benzophenone and benzophenone derivatives, octocrylene, avobenzene and camphor derivatives, and also to the laminates produced using these adhesives. It additionally relates to a process for producing these laminates and to their use for producing no-label-look labels.

This application claims benefit under 35 U.S.C. 119(a) of German patent application DE 10 2007 005 508.2, filed on 3 Feb. 2007.

Any foregoing applications, including German patent application DE 10 2007 005 508.2, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

Citation or identification of any document in this application is not an admission that such document is available as prior art to the present invention.

The invention relates to innovative laminates for no-label-look labels and also to the acrylate dispersion adhesives they contain. It additionally relates to a process for producing these laminates and to their use for producing self-adhesive no-label-look labels.

Self-adhesive labels are employed in a multiplicity of applications. They are used, for example, for the highlighting and marking of products, goods, articles of use or containers.

Prior to application, the label with a pressure-sensitive adhesive is generally adhered to what is called a release film or release paper. In both cases this is a flat backing which has been furnished with a release coating that reduces the propensity of the pressure-sensitive adhesive to adhere to the backing. It is important here that the adhesion between label and backing is set so that the label can be deliberately peeled or removed from the backing.

The level of adhesion of the adhesive labels to the backing must be sufficient for labels, when applied by machine, for example, not to detach prematurely as they run via deflecting rolls. On the other hand, however, the labels must be able to be peeled from the coated backing film or backing paper without any substantial deterioration in their bond strength for subsequent use. The various pressure-sensitive adhesives require release coatings set to different levels of abhesion. The assembly formed from label and release film or release paper is referred to as the laminate.

The force required to peel a label from the release paper or release film is referred to as the release force, and is reported typically in cN/2.5 cm.

The backing paper or backing film is equipped with a release coating by applying what is called an abhesive coating compound to the backing and then curing this compound.

The compounds used in the prior art for producing release coatings include reactive siloxanes, which are crosslinked by the action of temperature or by means of ultraviolet (UV) radiation or electron beams. In general a suitable catalyst or initiator is added which is activated by the action of temperature, UV radiation or electron beams and so starts the chemical reaction that leads to curing.

Radiation-curing abhesive coating compounds which cure by a free-radical mechanism are described in U.S. Pat. No. 4,421,904 A, U.S. Pat. No. 4,547,431 A, U.S. Pat. No. 4,952,657 A, U.S. Pat. No. 5,217,805 A, U.S. Pat. No. 5,279,860 A, U.S. Pat. No. 5,340,898 A, U.S. Pat. No. 5,360,833 A, U.S. Pat. No. 5,650,453 A, U.S. Pat. No. 5,866,261 A and U.S. Pat. No. 5,973,020 A and also U.S. Pat. No. 4,201,808 A, U.S. Pat. No. 4,568,566 A, U.S. Pat. No. 4,678,846 A, U.S. Pat. No. 5,494,979 A, U.S. Pat. No. 5,510,190 A, U.S. Pat. No. 5,552,506 A, U.S. Pat. No. 5,804,301 A, U.S. Pat. No. 5,891,530 A and U.S. Pat. No. 5,977,282 A. Mixtures of two or more such coating compounds with different chain lengths and/or types of modification are mentioned in U.S. Pat. No. 6,548,568 B and U.S. Pat. No. 6,268,404 B and also in the Goldschmidt publication “TEGO® RC Silicones, Application Guide”. The polymerizable groups in such systems are typically acrylate groups.

Radiation-curing abhesive coating compounds which cure by a cationic mechanism are described for example in U.S. Pat. No. 5,057,549 A, U.S. Pat. No. 5,231,157 A, U.S. Pat. No. 4,421,904 A, U.S. Pat. No. 4,547,431 A, U.S. Pat. No. 4,952,657 A, U.S. Pat. No. 5,217,805 A, U.S. Pat. No. 5,279,860 A, U.S. Pat. No. 5,340,898 A, U.S. Pat. No. 5,360,833 A, U.S. Pat. No. 5,650,453 A, U.S. Pat. No. 5,866,261 A and U.S. Pat. No. 5,973,020 A. The polymerizable groups in systems of this kind are typically epoxy groups.

In the case of UV crosslinking, photoinitiators are added to the organosilicon compounds. Suitable photoinitiators are given in references including J. P. Fouassier, “Polymerization photoinitiators: Excited state process and kinetic aspects”, Progress in Organic Coating, 18 (1990), 229-252, in J. P. Fouassier, “Photochemical reactivity of UV radical photoinitiators of polymerisation: A general discussion”, Recent Res. Devel. Photochem. & Photobiol., 4 (2000), 51-74, in D. Ruhlmann et al., “Relations structure-propiétés dans les photoamorceurs de polymerisation-2. Dérives de Phényle Acétophénone”, Eur. Polym. J. Vol. 28, No. 3, pp. 287-292, 1992, and in K. K. Dietliker, “Chemistry & Technology of UV & EB Formulation for Coatings, Inks & Paints”, Volume 3, Sita Technology Ltd., UK, and also in DE-A-102 48 111 and U.S. Pat. No. 4,347,111 A.

Self-adhesive labels are typically produced by first furnishing the backing with a release coating to give the release paper or release film. The adhesive is then applied to the release paper or release film and is cured if desired. In a further step the face stock is laminated on to give the completed laminate. In order to obtain a label ready for application, the face stock is generally then printed and provided if desired with further finishes. Finally the label can be die-cut and converted.

The inks used for printing are cured generally by means of UV irradiation. Typically up to 12 inks are used for one print. The label is therefore subjected to multiple UV irradiation.

For some time now there has been a trend towards what are called no-label-look labels (also known as no-look labels), of which a feature is that the face stock is a transparent film. A film of this kind is typically produced from PE (polyethylene) or PP (polypropylene).

No-label-look labels find application in particular in the cosmetics industry for the decoration and distinction of personal care products. No-label-look labels are also prevalent in consumer products, e.g. being applied to glass or plastic beverage bottles.

Adhesives used are frequently acrylate dispersion adhesives, but also include hotmelts, including UV hotmelts. A typical aqueous acrylate dispersion adhesive has a solids fraction of approximately 40% to 60% by weight. Of this figure, about 10% to 60% by weight is accounted for by a polymer dispersion, of an acrylate polymer, for example; about 0% to 50% by weight by a tackifier dispersion for adjusting the tack; about 0.5% to 1.5% by weight by a wetting agent; and about 0.1% to 0.5% by weight by a defoamer. Also included, additionally, are thickeners and ammonia. For film labels, dispersion adhesives without tackifiers are generally employed.

In the course of the production of these no-label-look labels it has been observed that the force required to part the label from the release paper or release film (release force) increases significantly after the printing operation in comparison to the unprinted state. This effect can be so pronounced as to impair machine detachment or dispensing of the labels.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

It was an object of the present invention, therefore, to reduce this unwanted increase in release force during the production of no-label-look labels.

Surprisingly, it has been found that the above-described increase in release force during the production of labels can be reduced significantly if an acrylate dispersion adhesive is used to which small amounts of a suitable UV absorber have been added.

The present invention therefore provides acrylate dispersion adhesives for producing laminates for no-label-look labels, containing at least one UV absorber selected from the group consisting of benzoic esters and benzoic ester derivatives, cinnamic esters and cinnamic ester derivatives, benzophenone and benzophenone derivatives, octocrylene, avobenzene and camphor derivatives.

Preferred benzoic ester derivatives are, for example, 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl benzoate, isononyl benzoate, octadecyl 3,5-di-tert-butyl-4-hydroxybenzoate, 2-methyl-4,6-di-tert-butylphenyl 3,5-di-tert-butyl-4-hydroxybenzoate or ethyl 4-aminobenzoate.

Preferred cinnamic ester derivatives are, for example, ethyl 4-methoxycinnamate, octyl 4-methoxycinnamate, isoamyl cinnamate or 2-ethylhexyl cinnamate.

Preferred UV absorbers are also benzophenone and substituted benzophenone derivatives, e.g. oxybenzone ((2-hydroxy-4-methoxyphenyl)phenylmethanone) or dioxy-benzone ((2-hydroxy-4-methoxyphenyl)(2-hydroxyphenyl)-methanone). Also suitable are octocrylene or avobenzene, as are obtainable under the trade name Parsolo 1789, Eusolex® 9020 or Escalol® 517, and also camphor derivatives such as 4-methylbenzylidenecamphor.

The acrylate dispersion adhesive of the invention preferably contains from 0.05% to 2% by weight, more preferably up to 1% by weight, of UV absorber. For instance, just 0.05% to 2% by weight of UV absorber, based on the cured adhesive (dry concentration), are sufficient to achieve a marked reduction in the increase in release force. In many cases, concentrations of just up to 1% by weight are enough. The UV absorber can be added to the adhesive in pure form or in the form of an emulsion or dispersion.

In accordance with the invention it is possible to use any commercial acrylate dispersion adhesives. Preference is given to aqueous acrylate dispersion adhesives having a solids fraction of about 40% to about 60% by weight based on the weight of the acrylate dispersion adhesive.

Of this figure, about 10% to 60% by weight is accounted to a polymer dispersion of an acrylate polymer, for example; about 0% to 50% by weight by a tackifier dispersion for adjusting the tack; about 0.5% to 1.5% by weight by a wetting agent; and about 0.1% to 0.5% by weight by a defoamer. All % by weight here is based on the weight of the solids fraction.

In addition thickeners and ammonia may also be included. Examples of commercial acrylate dispersion adhesives that are preferred in accordance with the invention include the products CR 62, CR 23 and A 220 from BASF.

The present invention further provides laminates for no-label-look labels, comprising a backing film or backing paper, a radiation-cured abhesive release coating, an adhesive layer and a transparent face stock, whose adhesive layer contains an acrylate dispersion adhesive of the invention.

In one preferred embodiment of the present invention the release coating contains cationically cured epoxysiloxanes, of the kind present in the products TEGO® RC 1402, RC 1403, RC 1406 and RC 1411 of Goldschmidt GmbH.

In a further preferred embodiment of the present invention the release coating contains free-radically cured silicone acrylates, of the kind present in the products TEGO® RC 902, RC 726, RC 711 (silicone acrylate), RC 708, RC 709, RC 715 and RC 706 of Goldschmidt GmbH.

The present invention further provides a process for producing the laminates of the invention, comprising the steps of
a) applying a release coating to a backing film or backing paper,
b) applying an adhesive layer to the release film or release paper obtained from step a) and curing it if desired,
c) laminating a transparent face stock onto the adhesive layer applied in step b),
   and also the use of the laminates of the invention for producing self-adhesive no-label-look labels.

The invention is further described by the following non-limiting examples which further illustrate the invention, and are not intended, nor should they be interpreted to, limit the scope of the invention.

### EXAMPLES

The performance properties were examined by applying a mixture of 70 parts of Tego RC 902, 30 parts of Tego RC 711 and 2 parts of Tego photoinitiator A 17 to flat backings (biaxially oriented polypropylene film, Poli-M 514) and curing the applied composition by exposure to UV light from a prior-art medium-pressure mercury vapour lamp with a UV output of 50 W/cm, under nitrogen blanketing with a controlled residual oxygen content of <50 ppm, at a web speed of 20 m/min. The application rate in each case is about 1 g/m².

Tego RC 902 and Tego RC 711 are commercial silicone acrylates from Goldschmidt GmbH. Tego photoinitiator A 17 is a commercial photoinitiator from Goldschmidt GmbH. The Poli-M 514 film was obtained from Polinas (Turkey).

The release film obtained was coated with different dispersion adhesives, with a dry application weight (weight after drying) of approximately 20 g/m². The adhesives used were CR 62, CR 23 and A 220 from BASF AG. The dispersion adhesives were used both with UV absorber, in accordance with the invention, and without UV absorber. Subsequently the adhesives were dried at approximately 100° C. in a drying oven and laminated with a PE film (Groflex 85 μm PE, clear). The laminate obtained was then irradiated one time and eight times with a laboratory UV lamp (80 W/cm) equipped with a conveyor belt in such a way that the lamp passes at a speed of 10 m/min.

The treated laminates were then measured for their release force.

Release Force Measurement:

For the determination of the release forces a strip of the laminate 25 mm wide is used. To measure the abhesiveness, this strip is fixed and then a measurement is made of the force required to separate the respective laminate at a speed of 30 cm/min and at a peel angle of 180°. This force is termed the release force. The general test procedure corresponds to test method No. 10 of the “Fédération Internationale des Fabricants et Transformateurs D'Adhésifs et Thermocollants sur Papier et autres Supports” (FINAT).

The results are compiled in the tables below.

TABLE 1
Variation of the UV absorber

| | | Release | Release | Release |
|---|---|---|---|---|
| | | force | force after | force after |
| | | without UV | one UV | 8-fold UV |
| Adhesive | | irradiation | irradiation | irradiation |
| used | UV Absorber¹ | [cN/2.5 cm] | [cN/2.5 cm] | [cN/2.5 cm] |
| CR 62 | — | 4 | 8 | 15 |
| (BASF) | | | | |
| CR 62 | 2-Ethylhexyl | 4 | 4 | 12 |
| (BASF) | 4-methoxy- | | | |
| | cinnamate | | | |
| CR 62 | Isoamyl | 4 | 4 | 8 |
| (BASF) | cinnamate | | | |
| A 220 | — | 3 | 9 | 21 |
| (BASF) | | | | |
| A 220 | 2-Ethylhexyl | 4 | 8 | 17 |
| (BASF) | 4-methoxy- | | | |
| | cinnamate | | | |
| CR 23 | — | 4 | 9 | 20 |
| (BASF) | | | | |
| CR 23 | 2-Ethylhexyl | 3 | 7 | 17 |
| (BASF) | 4-methoxy- | | | |
| | cinnamate | | | |

¹Dry concentration of the UV absorber in the adhesive = 0.6% by weight.

TABLE 2
Variation in the UV absorber concentration

| Concentration of | Release force | Release force | Release force |
|---|---|---|---|
| the UV | without UV | after one UV | after 8-fold |
| absorber^{1,2} | irradiation | irradiation | UV irradiation |
| [% by wt.] | [cN/2.5 cm] | [cN/2.5 cm] | [cN/2.5 cm] |
| 0 | 4 | 8 | 15 |
| 0.2 | 4 | 5 | 12 |
| 0.4 | 4 | 4 | 9 |
| 0.6 | 4 | 4 | 8 |

¹Adhesive used: CR 62 (BASF)
²Dry concentration in the adhesive, UV absorber used: isoamyl cinnamate

The results show that the addition of UV absorber to the adhesive in accordance with the invention is able to achieve a significant reduction in the increase in the release forces after UV irradiation.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. An acrylate dispersion adhesive for producing a laminate for no-label-look labels, containing at least one UV absorber selected from the group consisting of benzoate esters and benzoic ester derivatives, cinnamic esters and cinnamic ester derivatives, benzophenone and benzophenone derivatives, octocrylene, avobenzene and camphor derivatives.

2. An acrylate dispersion adhesive according to claim 1, characterized in that the UV absorbers are selected from the group consisting of 4-tert-butylphenyl salicylate, phenyl salicylate, octylphenyl salicylate, dibenzoylresorcinol, bis(4-tert-butylbenzoyl)-resorcinol, benzoylresorcinol, 2,4-di-tert-butylphenyl 3,5-di-tert-butyl-4-hydroxybenzoate, hexadecyl benzoate, isononyl benzoate, octadecyl 3,5-di-tert-butyl-4-hydroxybenzoate, 2-methyl-4,6-di-tert-butyl-phenyl 3,5-di-tert-butyl-4-hydroxybenzoate and ethyl 4-aminobenzoate.

3. An acrylate dispersion adhesive according to claim 1, characterized in that the UV absorbers are selected from the group consisting of ethyl 4-methoxycinnamate, octyl 4-methoxycinnamate, isoamyl cinnamate and 2-ethylhexyl cinnamate.

4. An acrylate dispersion adhesive according to claim 1, characterized in that the UV absorbers are selected from the group consisting of (2-hydroxy-4-methoxy-phenyl)phenylmethanone, (2-hydroxy-4-methoxyphenyl)-(2-hydroxyphenyl)methanone, octocrylene, avobenzene and 4-methylbenzylidenecamphor.

5. An acrylate dispersion adhesive according to claim 1, characterized in that the amount of UV absorber present is 0.05% to 2% by weight, based on the solids fraction of the acrylate dispersion adhesive.

6. An acrylate dispersion adhesive according to claim 1, characterized in that the amount of UV absorber present is up to 1% by weight, based on the solids fraction of the acrylate dispersion adhesive.

7. A laminate for no-label-look labels, comprising a backing film or backing paper, a radiation-cured abhesive release coating, an adhesive layer and a transparent face stock, characterized in that the adhesive layer contains an acrylate dispersion adhesive according to claim 1.

8. A laminate according to claim 7, characterized in that the release coating contains cationically cured epoxysiloxanes.

9. A laminate according to claim 7, characterized in that the release coating contains free-radically cured silicone acrylates.

10. A process for producing a laminate for no-label-look labels, comprising the steps of
a) applying a release coating to a backing film or backing paper,
b) applying an adhesive layer to the release film or release paper obtained from step a) and curing it if desired,
c) laminating a transparent face stock onto the adhesive layer applied in step b),
characterized in that an acrylate dispersion adhesive according to claim 1 is used for the application of the adhesive layer.

11. A method of producing self-adhesive no-label-look labels which comprises of applying the laminate of claim 7 to a label.

12. The acrylate dispersion adhesive of claim 1, wherein the acrylate dispersion adhesives has a solids fraction of about 40% to 60% by weight based on the weight of the acrylate dispersion adhesive.

13. The acrylate dispersion adhesive of claim 12, wherein the solids fraction comprises:
about 10% to 60% by weight of a polymer dispersion of an acrylate polymer;
about 0% to 50% by weight of a tackifier dispersion for adjusting the tack;
about 0.5% to 1.5% by weight of a wetting agent; and
about 0.1% to 0.5% by weight of a defoamer with the % by weight based on the amount of solids fraction.

14. The acrylic dispersion of claim 13, wherein the amount of UV absorber present is 0.05% to 2% by weight, based on the solids fraction of the acrylate dispersion adhesive; and
the UV absorbers are selected from the group consisting of 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl benzoate, isononyl benzoate, octadecyl 3,5-di-tert-butyl-4-hydroxybenzoate, 2-methyl-4,6-di-tert-butylphenyl 3,5-di-tert-butyl-4-hydroxybenzoate and ethyl 4-aminobenzoate.

15. The acrylic dispersion of claim 13, wherein the amount of UV absorber present is 0.05% to 2% by weight, based on the solids fraction of the acrylate dispersion adhesive; and
the UV absorbers are selected from the group consisting of ethyl 4-methoxycinnamate, octyl 4-methoxycinnamate, isoamyl cinnamate and 2-ethylhexyl cinnamate.

16. The acrylic dispersion of claim 13, wherein the amount of UV absorber present is 0.05% to 2% by weight, based on the solids fraction of the acrylate dispersion adhesive; and
the UV absorbers are selected from the group consisting of (2-hydroxy-4-methoxyphenyl)phenylmethanone, (2-hydroxy-4-methoxyphenyl)(2-hydroxyphenyl)methanone, octocrylene, avobenzene and 4-methylbenzylidenecamphor.
